(19) United States
(12) Patent Application Publication
(10) Pub. No.: US 2024/0347830 A1
(43) Pub. Date: Oct. 17, 2024

(54) Housing for Electrode Stacks and Battery Cell Group

(71) Applicant: Bayerische Motoren Werke Aktiengesellschaft, Muenchen (DE)

(72) Inventors: Holger HAIN, Ismaning (DE); Benjamin WEBER, Neufahrn b. Freising (DE)

(21) Appl. No.: 18/682,994

(22) PCT Filed: Aug. 17, 2022
(86) PCT No.: PCT/EP2022/072951

§ 371 Date: Feb. 12, 2024

(30) Foreign Application Priority Data
Aug. 31, 2021 (DE) 10 2021 122 486.1

(51) Int. Cl. H01M 50/209; H01M 10/04; H01M 10/613; H01M 10/6556; H01M 50/103; H01M 50/119; H01M 50/26; H01M 50/502

(52) U.S. Cl. CPC H01M 50/209; H01M 10/0431; H01M 10/613; H01M 10/6556; H01M 50/103; H01M 50/119; H01M 50/26; H01M 50/502

(57) ABSTRACT

A housing for receiving electrode stacks has (i) at least three individual housings, wherein: (ii) each individual housing includes a prism having a base surface and side surfaces, the base surface having a polygon that includes at least five vertices; (iii) the prism has a cavity, which is suitable for receiving a cylindrical electrode stack, the cavity extending between the base surface and a top surface of the prism; (iv) each of the three individual housings is mechanically connected, by two of its side surfaces, to one side surface of each of the two other individual housings.

### BACKGROUND AND SUMMARY

The present invention relates to a housing for electrode stacks, to a battery cell group and to a method for the production of a battery cell group.

In the field of battery cells, particularly of lithium-ion battery cells, cylindrical, prismatic and pouch-shaped battery cells are mainly known.

In cylindrical battery cells, cylindrically shaped electrode stacks, also known as electrode windings, can be installed in particular in a cylindrical housing. The arrangement of cylindrical battery cells in a rectangular housing, which allows a battery module to be formed, can be associated with disadvantages here. Due to the different geometries of the housing of the battery cell and the housing of the battery module, there is a smaller overlapping contact surface between the housing of the battery module and the housing of the battery cell for the attachment of the battery cell to the housing of the battery module than would be the case if the housing of the battery cell and the battery module were each to have a rectangular shape, for example. This can lead to less attachment stability. The same applies to the arrangement of a plurality of cylindrical battery cells in a rectangular housing. This may also require a mechanical connection of cylindrical battery cells to each other, which can also lead to a mechanical connection with a smaller overlapping contact surface.

The object of the present disclosure is to provide a stable housing in which a number of cylindrical electrode stacks can be stably arranged.

The solution to this object may be achieved in accordance with the teaching of the independent claims. Various embodiments and further embodiments of the invention are the subject matter of the dependent claims.

A first aspect of the disclosure relates to a housing for receiving electrode stacks, comprising (i) at least three individual housings, wherein (ii) each individual housing comprises a prism with, as its base surface, a polygon comprising at least five vertices, and wherein (iii) the prism comprises a cavity suitable for receiving a cylindrical electrode stack, wherein the cavity extends between the base surface and a top surface of the prism, wherein (iv) each of the at least three individual housings is mechanically connected by way of two of its side surfaces to a respective side surface of the two other individual housings.

The terms “comprises”, “contains”, “includes”, “encompasses”, “has”, “with” optionally used here, or any other variant thereof, are intended to cover a non-exclusive inclusion. For example, a method or a device that comprises or has a list of elements is thus not necessarily limited to those elements but may include other elements that are not expressly listed or that are inherent to such a method or to such a device.

Further, unless expressly stated otherwise, “or” refers to an inclusive “or” and not to an exclusive “or”. For example, a condition A or B is satisfied by one of the following conditions: A is true (or present) and B is false (or not present), A is false (or not present) and B is true (or present), and both A and B are true (or present).

The terms “a/an” or “one” as used herein are defined in the sense of “one or a plurality of”. The terms “another” and “a further” as well as any other variant thereof are to be understood in the sense of “at least one other”.

The term “plurality”, as used here, is to be understood in the sense of “two or more”.

For the purposes of the disclosure, the term “configured” or “set up” to perform a specific function (and respective variations thereof) is to be understood to mean that the corresponding device already exists in an embodiment or setting in which it can perform the function or it is at least settable—i.e., configurable—in such a way that it can perform the function after appropriate setting. The configuration can be carried out here, for example, by appropriately setting parameters of a process sequence or switches or similar to activate or deactivate functionalities or settings. In particular, the device may have a plurality of predetermined configurations or modes of operation so that the configurating can be carried out by way of a selection of one of these configurations or modes of operation.

For the purposes of this disclosure, an electrode stack, in particular an electrochemical electrode stack, is to be understood, in particular, as a device which serves, in particular, to provide electrical energy, which is designed, in particular, for the conversion of chemical energy into electrical energy, and which is preferably designed for the conversion of electrical energy into chemical energy. For this purpose, the electrode stack can comprise a plurality of stack layers, wherein at least one of the stack layers is designed as a cathodic electrode, as an anodic electrode or as a separator. The electrode stack can comprise at least one of the cathodic electrodes, at least one of the anodic electrodes, and at least one of the separators. The electrode stack can comprise a sequence of stack layers, in which the separator is arranged between the cathodic electrode and the anodic electrode, i.e., cathodic electrode-separator-anodic electrode. Preferably, the electrode stack comprises a plurality of these sequences. Preferably, one or a plurality of the stack layers each has an essentially rectangular shape. Preferably, at least one of these separators in the electrode stack projects above the adjacent cathodic electrode and/or above the adjacent anodic electrode. The separator may be permeable to ions but not to electrons. For this purpose, the separator may comprise an electrolyte or a conductive salt. Preferably, the electrolyte or the conductive salt has lithium ions. Preferably, the electrode stack can be configured as an “electrode winding,” wherein the electrodes of the first polarity, the electrodes of the second polarity, and the separator are arranged wound around a common axis, thereby allowing an essentially cylindrical shape to be formed.

The housing according to the first aspect makes it possible to achieve a high degree of mechanical stability as a whole, since each individual housing is mechanically connected to a side surface of the two other individual housings by way of two of its side surfaces. Since the base surface of the polygon comprises at least five vertices, a force acting on one side surface of an individual housing and at least partially in the direction of the two other individual housings connected to this individual housing acts on the two other individual housings from different directions. As a result, the two other individual housings counteract the force from different directions. This can prevent the individual housings from being displaced in relation to each other when the force is applied.

In the following, preferred embodiments of the housing are described, each of which, unless expressly excluded or technically impossible, can be combined with each other as desired, as well as with the further described other aspects of the disclosure.

In some embodiments, the cavity comprises a hollow cylinder with a circular or elliptical cross section. The hollow cylinder is preferably designed to essentially receive the cylindrical electrode stack in a precise manner. By precisely receiving the cylindrical electrode stack, it can be achieved that an existing installation space of the hollow cylinder is filled by the cylindrical electrode stack essentially completely. This also makes it possible to optimize the maximum capacitance of a cylindrical electrode stack that can be arranged in the installation space.

In some embodiments, at least one mechanical connection between the individual housings comprises a material connection, in particular a solder, weld or adhesive connection. This makes it possible to achieve that a stable connection between the individual cells is established, which requires little installation space.

In some embodiments, the individual housings each have metal. In this way, it can be achieved that heat generated during the operation of a battery cell in which the present individual housings are used can be dissipated through the individual housings. Metals are known to be good conductors of heat. In addition, the mechanical connection of the individual housings with at least two adjacent individual housings can be used to achieve a heat balance between the individual housings.

In some embodiments, the polygon comprises a hexagon. This can optimize the ratio of a total volume of the cavities of the individual housings to a total volume of the housing. This can be made possible by arranging the individual housings in a hexagonal closest packing. Due to cylindrical electrode stacks arranged in the respective cavities, a resulting total capacitance can be optimized with respect to all electrode stacks, each of which is arranged in a cavity of an individual housing of the housing with respect to the required total volume of the housing.

In some embodiments, the individual housings each have a housing wall arranged between the cavities and the side surfaces, wherein at least one housing wall of an individual housing comprises a recess extending from the base surface to the top surface of the prism, allowing a fluid to flow through the recess within the housing wall from the base surface to the top surface of the prism. This makes it possible for a fluid, particularly a gas or a liquid, to be able to flow through the recess during the operation of a battery cell using the individual housing, and, at an appropriate temperature of the fluid, a thermal energy exchange between the fluid and the individual housing can occur. In particular, cooling of the battery cell can be achieved when a fluid flows through the recess at a significantly lower temperature than the battery cell.

In some embodiments, at least one section of the housing is designed as a single piece, wherein the section comprises at least two individual housings. As a result, additional mechanical stability can be achieved, since there is no need for a separate connection between the at least two individual housings. Furthermore, the heat conduction between the at least two individual housings can be improved, since there is no need for a separate connection between the two individual housings. Accordingly, a reduction in the heat conduction at the connection between the two individual housings is possible.

A second aspect of the disclosure relates to a battery cell group comprising (i) a housing in accordance with the first aspect, (ii) at least three cylindrical electrode stacks, wherein in each case a cylindrical electrode stack is arranged in a cavity of an individual housing, and (iii) an electrical connecting element via which the electrode stacks are electrically connected to each other, in particular serially connected or connected in parallel. This makes it possible to provide a battery cell group with at least three electrode stacks, and thus providing an electrical capacity of at least three electrode stacks, in the housing with a high level of stability.

In some embodiments, the battery cell group comprises a further housing in accordance with the first aspect, as well as at least three cylindrical electrode stacks, wherein in each case a cylindrical electrode stack is arranged in a cavity of an individual housing of the further housing, wherein the housing and the further housing are mechanically connected to each other, and wherein the cylindrical electrode stacks of the housing are electrically connected to each other by the cylindrical electrode stacks of the further housing, in particular serially connected or connected in parallel. By electrically connecting the electrode stacks of the housing to the electrode stacks of the further housing, the capacity of the battery cell group can be increased overall, and additional mechanical stability can be achieved by way of a larger number of individual housings connected to one another.

In some embodiments, the cylindrical electrode stacks are each arranged in an inner cell housing, wherein the inner cell housings with the cylindrical electrode stacks are each arranged in the cavities of the individual housings. This makes it possible to achieve that the cylindrical electrode stacks can each be arranged in an inner cell housing during production, and thus the cylindrical electrode stacks are secured against mechanical effects when transported to a manufacturer where the battery cell group is manufactured according to the invention.

A third aspect of the disclosure relates to a method for producing a battery cell group in accordance with the second aspect, comprising the steps: (i) production of at least three individual housings, wherein each individual housing comprises a prism with a polygon comprising more than five vertices as its base surface, and wherein the prism comprises a cavity suitable to receive a cylindrical electrode stack, wherein the cavity extends between the base surface and a top surface of the prism; (ii) connection of the individual housings into one housing, wherein each of the three individual housings are mechanically connected by way of two of its side surfaces to a respective side surface of the two other individual housings; (iii) arranging of in each case one cylindrical electrode stack in a respective cavity; and (iv) electrical connection of the electrode stacks.

In some embodiments, the production of the at least three individual housings comprises a step involving extrusion. By using extrusion, the individual housings can be separately produced in an effective and cost-efficient manner.

The features and advantages explained in relation to the first aspect of the disclosure also apply mutatis mutandis to the other aspects of the disclosure.

Further advantages, features and application options of the present technology are given in the following detailed description in connection with the figures.

### BRIEF DESCRIPTION OF THE DRAWINGS

The figures show

FIG. 1A schematically a top view of an example of an individual cell;

FIG. 1B schematically a perspective view of the individual cell of the first example;

FIG. 2 schematically a top view of a second example of an individual cell;

FIG. 3A schematically a top view of a battery cell group in accordance with an exemplary embodiment; and

FIG. 3B schematically a top view of a battery cell group in accordance with another exemplary embodiment.

In the figures, the same reference numbers are used throughout for the same or mutually corresponding elements of the invention.

### DETAILED DESCRIPTION OF THE DRAWINGS

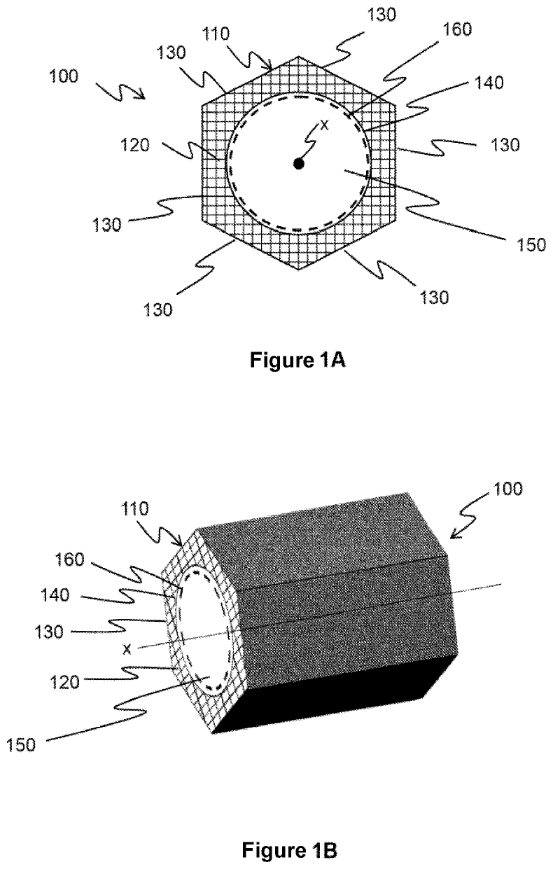

FIG. 1A schematically shows a top view of an individual cell 100 of a first example. The individual cell 100 comprises an individual housing 110, which is designed as a prism with a base surface with six vertices, also known as a hexagon. The prism comprises a housing wall 120 with six equally sized side surfaces 130, which form the lateral surface of the prism. The individual housing 100 can also comprise a base plate and a cover in the installed state (not shown here). The prism comprises a hollow cylinder 140 with a cylindrical axis x, which extends between the base surface and a top surface of the prism, and is enclosed by an inner side of the housing wall 120. The hollow cylinder comprises a circular cross section. It is also possible that the hollow cylinder 140 comprises an elliptical cross section. A cylindrical electrode stack, also known as electrode winding 150, is arranged in the hollow cylinder 140, which can be electrically contacted via openings on the front sides of the hollow cylinder 140 or through a base plate or a cover arranged on one of the front sides.

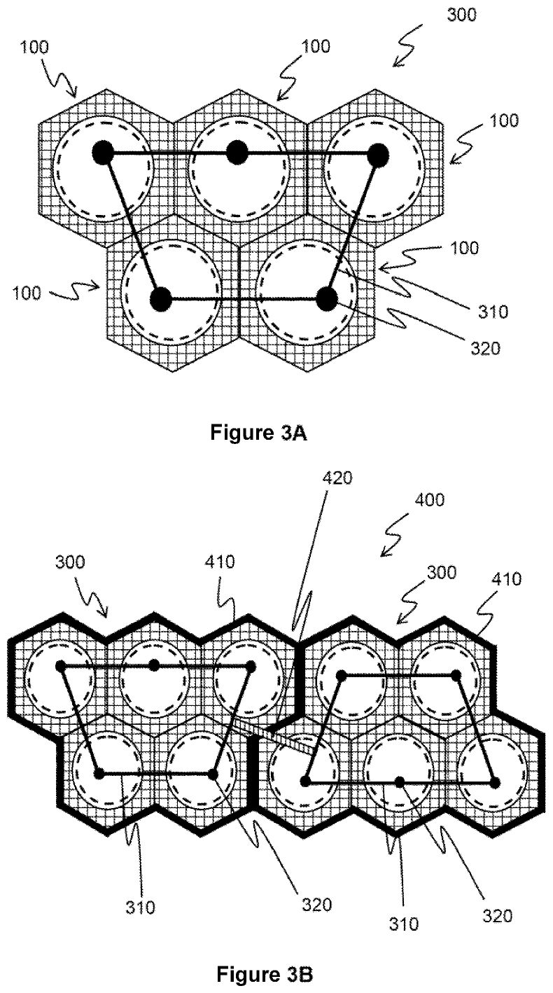

In an optional configuration, the electrode winding 150 is arranged in an inner cell housing 160. The inner cell housing 160 with the electrode winding 150 arranged in it is precisely arranged here in the hollow cylinder 140 of the individual housing 110. This additional inner cell housing 160 can be advantageous, particularly if the electrode winding 150 and a battery cell group in accordance with FIGS. 3A and 3B are manufactured by different manufacturers. In this case, the electrode winding 150 can be arranged in the inner cell housing 160 before delivery to the manufacturer of the battery cell group, which allows the electrode winding 150 to be better protected against external influences during transport to the manufacturer of the battery cell group.

FIG. 1B schematically shows a perspective view of the individual cell 100 of the first example.

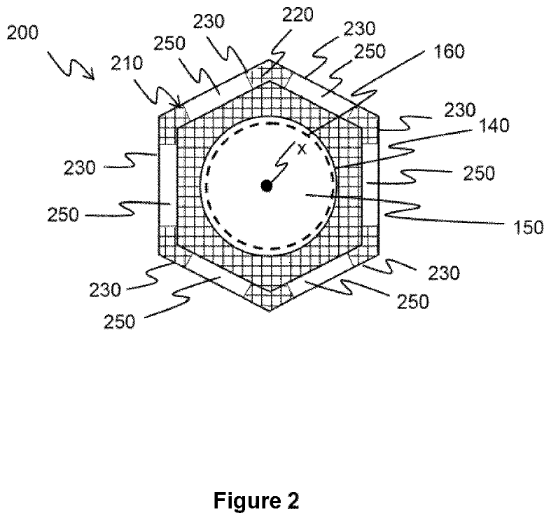

FIG. 2 schematically shows a top view of an individual cell 200 of a second example. In contrast to the individual cell 100 of the first example in accordance with FIGS. 1A and 1B, the individual cell 200 in accordance with the present second example comprises individual housings 210 with a housing wall 220 with recesses 250 arranged in sections. These recesses 250 extend within the housing wall 220 between the hollow cylinder 140 and the respective side surfaces 230 of the prism, between the front sides of the hollow cylinder. The present housing wall 220 comprises six recesses 250, which essentially comprise an identical cross-sectional area. These recesses 250 can be used to cool the individual cell 100, for example, by passing a gas or a liquid with an appropriate temperature required for cooling through the recesses 250. This cooling allows for cooling immediately adjacent to the electrode winding 150, thereby enabling a low thermal conductivity path to the electrode winding 150. In the case of correspondingly long individual cells 100, counterflow cooling is also conceivable.

FIG. 3A schematically shows a top view of an exemplary embodiment of a battery cell group 300 of a plurality of individual cells 100. The battery cell group 300 comprises five individual cells 100 in accordance with the first exemplary embodiment in accordance with FIGS. 1A and 1B. It would also be possible for the battery cell group 300 to comprise individual cells 200 in accordance with the second exemplary embodiment according to FIG. 2. Furthermore, a mixed composition would be conceivable, according to which the battery cell group 300 comprises both one or a plurality of individual cells 100 of the first exemplary embodiment as well as one or a plurality of individual cells 200 of the second exemplary embodiment. The individual cells 100 are mechanically connected to each other by sections of their respective housing walls 120. The individual cells 100 are arranged in relation to one another here in such a way that each individual cell 100 is mechanically connected to at least two further individual cells 100. Since the individual cells 100 each comprise a cross section in the form of a hexagon, a hexagonal honeycomb structure is achieved via the connection between the respective sections of the side surfaces 130. This structure allows for a high level of mechanical strength, for example against forces acting from the outside on the structure. In addition, this structure makes it possible to minimize the total volume required while maintaining individual volumes of the electrode windings 150. The individual cells 100 are electrically connected to each other by an electrically conductive contact plate 310. The electrically conductive contact plate 310 is electrically connected to each of the electrode windings 150 of the individual cells with an electrode of the electrode winding 150 at a front side of the individual cells 100 by way of electrically conductive contact points 320, and the individual cells 100 or the electrode windings 150 arranged in each case therein are electrically connected to each other by the electrically conductive contact plate 310. The electrode windings 150 can be electrically connected to each other serially or in parallel. The housing can be connected to a positive electrical pole, and the electrically conductive contact plate 310 can be connected to a negative electrical pole. It is also possible for the housing to be connected to a negative electrical pole and the electrically conductive contact plate 310 to be connected to a positive electrical pole. Furthermore, battery cell groups 300 with a different number of individual cells 100 are conceivable, provided that individual cells 100 are mechanically connected to one another by at least two other individual cells via the surface sections of the hexagon. In this case, the battery cell group 300 comprises a particularly stable mechanical construction.

FIG. 3B schematically shows a top view of a battery cell group 400 that comprises two interconnected battery cell groups 300 in accordance with the previous exemplary embodiment. Each battery cell group 300 comprises here an electrical insulation 410, which in each case electrically insulates an entire outer side of each battery cell group 300. As a result, the battery cell groups 300 can be mechanically connected to each other without entailing an electrical connection. Both battery cell groups 300 shown each comprise an electrically conductive contact plate 310, which is electrically connected to an electrical pole of the respective electrode windings 150 by electrically conductive contact points 320. The two electrically conductive contact plates 310 of the two battery cell groups 300 are electrically connected to each other by an electrically conductive connecting rod 420. Likewise, the two electrically conductive contact plates 310 can be electrically connected to each other by way of an electrically conductive connecting line or an electrically conductive object. Through this described electrical connection of the two battery cell groups 300, an parallel electrical connection is established between the two battery cell groups 300, whereby the available and accessible total capacity can be increased. It is also conceivable to establish an serial electrical connection between the two battery cell groups 300 by way of an electrical connection of an electrical contact plate 310 with an electrical contact point 320, whereby the total voltage can be increased (not shown here).

While at least one exemplary embodiment has been described above, it should be noted that there are a large number of variations on it. It should also be noted here that the exemplary embodiments described are only non-limiting examples and it is not intended to thereby limit the scope, the applicability or the configuration of the devices and methods described herein. Rather, the preceding description will provide the person skilled in the art with guidance on how to implement at least one exemplary embodiment, wherein it is understood that various changes may be made in the functioning and the arrangement of the elements described in an exemplary embodiment without departing from the subject matter specified in each case in the attached claims and its legal equivalents in the process.

### LIST OF REFERENCES

100, 200 individual cell
110, 210 individual housing
120, 220 housing wall
130, 230 side surface
140, 240 hollow cylinder
150 electrode winding
160, 260 inner cell housing
x longitudinal axis of hollow cylinder, individual housing
250 recess
300 battery cell group
310 electrically conductive contact plate
320 electrically conductive contact point
400 battery cell group
410 electrical insulation
420 electrically conductive connecting rod

1-12. (canceled)

13. A housing for receiving electrode stacks, the housing comprising:
at least three individual housings, each individual housing comprising a prism having a base surface and side surfaces, the base surface comprising a polygon including at least five vertices, the prism comprising a cavity configured for receiving a cylindrical electrode stack, and the cavity extending between the base surface and a top surface of the prism, wherein
each of the at least three individual housings is mechanically connected by two of its side surfaces to a respective side surface of the two other individual housings.

14. The housing according to claim 13, wherein
the cavity comprises a hollow cylinder with a circular or elliptical cross section, the hollow cylinder being configured to receive the cylindrical electrode stack.

15. The housing according to claim 13, wherein
at least one mechanical connection between the at least three individual housings comprises a material connection.

16. The housing according to claim 15, wherein
the material connection is selected from the group consisting of a solder connection, a weld connection, and an adhesive connection.

17. The housing according to claim 13, wherein
each of the at least three individual housings comprises metal.

18. The housing according to claim 13, wherein
the polygon comprises a hexagon.

19. The housing according to claim 13, wherein
the at least three individual housings each comprise a housing wall arranged between the respective cavity and side surfaces, wherein at least one housing wall of an individual housing comprises a recess extending from the base surface to the top surface of the prism, whereby a fluid can flow through the recess within the housing wall from the base surface to the top surface of the prism.

20. The housing according to claim 13, wherein
at least one portion of the housing is designed as a single piece, and
the at least one portion comprises at least two individual housings.

21. A battery cell group comprising:
the housing according to claim 13;
at least three cylindrical electrode stacks, each of the at least three cylindrical electrode stacks being arranged in a cavity of one of the at least three individual housings; and
an electrical connecting element electrically connecting the cylindrical electrode stacks to each other.

22. The battery cell group according to claim 21, further comprising:
a further housing;
at least three cylindrical electrode stacks, each of the at least three cylindrical electrode stacks being arranged in a cavity of one of the at least three individual housings of the further housing, wherein
the housing and the further housing are mechanically connected to each other, and
the cylindrical electrode stacks of the housing are electrically connected to one another serially or in parallel by the cylindrical electrode stacks of the further housing.

23. The battery cell group according to claim 21, wherein the at least three cylindrical electrode stacks are each arranged in an inner cell housing, wherein the inner cell housings with the at least three cylindrical electrode stacks are each arranged in the cavities of the at least three individual housings.

24. A method for producing a battery cell group, the method comprising:
producing at least three individual housings, each individual housing comprising a prism having a base surface and side surfaces, the base surface comprising a polygon including more than five vertices, the prism comprising a cavity suitable for receiving a cylindrical electrode stack, the cavity extending between the base surface and a top surface of the prism;
connecting the at least three individual housings into one housing, wherein each of the at least three individual housings is mechanically connected by two of its side surfaces to a respective side surface of the two other individual housings;
arranging one cylindrical electrode stack in a respective cavity of each of the at least three individual housings; and
electrically connecting the cylindrical electrode stacks.

25. The method for producing a battery cell group according to claim 24, wherein producing the at least three individual housings comprises an extrusion step.
